(19) United States
(12) Patent Application Publication
(10) Pub. No.: US 2019/0019211 A1
(43) Pub. Date: Jan. 17, 2019

(54) DETECTING PROMOTION EXPOSURE THROUGH VOICE RECOGNITION AND LOCATION DATA

(71) Applicant: INTERNATIONAL BUSINESS MACHINES CORPORATION, Armonk, NY (US)

(72) Inventors: Ben Z. Akselrod, Givat Shmuel (IL); Anthony Di Loreto, Markham (CA); Steve McDuff, Ontario (CA); Kyle D. Robeson, North York (CA)

(21) Appl. No.: 15/647,328

(22) Filed: Jul. 12, 2017

(51) Int. Cl. G06Q 30/02; G10L 17/00

(52) U.S. Cl. CPC G06Q 30/0242; G06Q 30/0251; G10L 17/005; G06Q 30/0205; G06Q 30/0201

(57) ABSTRACT

According to one embodiment, a method, computer system, and computer program product for detecting a promotion exposure is provided. The present embodiment may include receiving a plurality of promotional data detailing one or more current promotions. The embodiment may also include receiving a plurality of audio data captured by a sensor. The embodiment may further include determining an exposure of an individual to a promotion within the one or more current promotions based on the received plurality of audio data and the received plurality of promotional data. The embodiment may also include identifying the individual exposed to the promotion using the received plurality of audio data. The embodiment may further include calculating a dwell time for the identified individual. The embodiment may also include determining the calculated dwell time satisfies a dwell time threshold. The embodiment may further include recording the exposure to a data repository.

### BACKGROUND

The present invention relates, generally, to the field of computing, and more particularly to advertising.

Advertising may relate to the audio or visual marketing communication of a product or service. The communication may include an openly sponsored message for the product or service. Typically, advertising messages may be displayed over old media outlets, such as television, radio, newspapers, or direct mailing. With the increasing prevalence the internet, new media, such as sponsored search results, blog posts, dedicated product websites, text messages, emails, or native advertising articles, may also be utilized to reach potential customers.

### SUMMARY

According to one embodiment, a method, computer system, and computer program product for detecting a promotion exposure is provided. The present embodiment may include receiving a plurality of promotional data detailing one or more current promotions. The embodiment may also include receiving a plurality of audio data captured by a sensor. The embodiment may further include determining an exposure of an individual to a promotion within the one or more current promotions based on the received plurality of audio data and the received plurality of promotional data. The embodiment may also include identifying the individual exposed to the promotion using the received plurality of audio data. The embodiment may further include calculating a dwell time for the identified individual. The embodiment may also include determining the calculated dwell time satisfies a dwell time threshold. The embodiment may further include recording the exposure to a data repository.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment;

FIG. 2 is an operational flowchart illustrating a promotion exposure tracking process according to at least one embodiment;

FIG. 3 is a block diagram of internal and external components of computers and servers depicted in FIG. 1 according to at least one embodiment;

FIG. 4 depicts a cloud computing environment according to an embodiment of the present invention; and

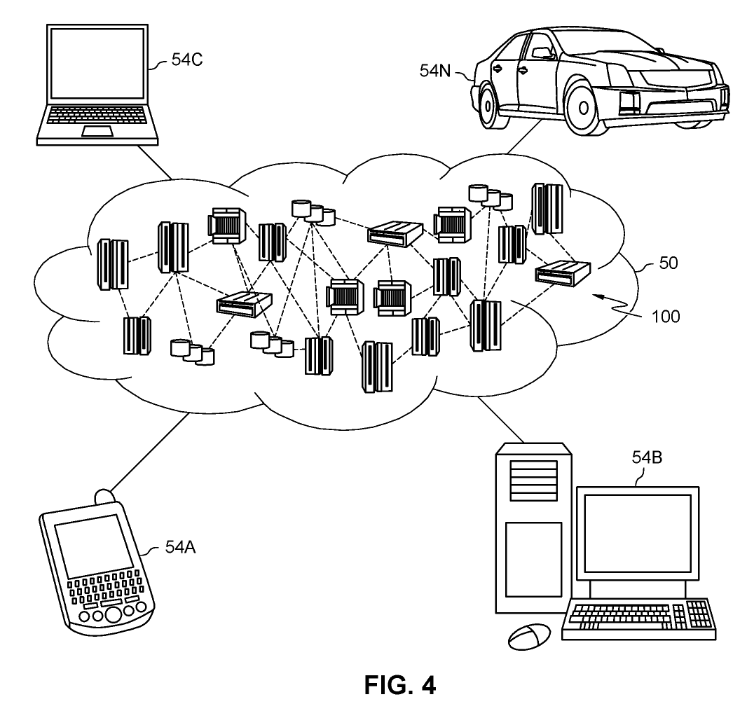

FIG. 5 depicts abstraction model layers according to an embodiment of the present invention.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

Embodiments of the present invention relate to the field of computing, and more particularly to advertising. The following described exemplary embodiments provide a system, method, and program product to, among other things, detect an individual's exposure to an ongoing promotion and, when the amount time with which the individual is exposed to the promotion exceeds a threshold, recording the exposure to a database. Therefore, the present embodiment has the capacity to improve the technical field of advertising by allowing marketing professionals to better train targeted advertisements. For example, if an individual was exposed to an advertisement but did not immediately purchase the advertised item, a follow up advertisement may entice the individual to follow through on the purchase of the advertised item. Similarly, if an individual has been exposed to an advertisement multiple times but hasn't purchased the advertised item, further promotions or advertisements may be reduced to that individual to reduce possibly wasted resources.

As previously described, advertising may relate to the audio or visual marketing communication of a product or service. The communication may include an openly sponsored message for the product or service. Typically, advertising messages may be displayed over old media outlets, such as television, radio, newspapers, or direct mailing. With the increasing prevalence the internet, new media, such as sponsored search results, blog posts, dedicated product websites, text messages, emails, or native advertising articles, may also be utilized to reach potential customers.

Detecting when an individual has been exposed to a promotion in a commerce system may be a useful metric to determine the effectiveness of each promotion. However, measurement of this metric may be troublesome since identifying when a specific individual is exposed to a promotion may be difficult in some circumstances. For example, when a shopper interacts with an employee in a store, no efficient way may exist to determine if either the employee or the shopper mentioned a specific promotion or if the exchange centered around non-promotional material, such as in which aisle a specific item is located. Since measuring an individual's exposure to a promotion may be difficult, an individual may be presented with the same promotion multiple times within quick succession, thereby unnecessarily using resources. For example, if the store employee and the customer in the previously described scenario discussed a promotion and the individual was sent an email about the same promotion a few minutes after the conversational exchange, the individual would have been exposed to the same promotion twice and, therefore, may feel as if the promotional company is spamming the individual. As such, it may be advantageous to, among other things, determine when an individual has been exposed to a promotion in order to tailor future marketing efforts directed toward that individual so that the individual is not over-exposed to the same promotional content.

According to one embodiment, audio recording devices may be utilized to determine when an individual is exposed to a promotion. Once the promotion is detected, a location tracking system may analyze the individual and any other individuals in the surrounding area that may have been exposed to the promotion to determine each individual's identity. Implementing a combination of proximity data and dwell time data, the promotion exposure of each identified individual may be determined. Once promotion exposure is measured, a user may analyze the data to determine if a promotional campaign should reinforce promotional messages to an exposed individual or mute future promotional communications to avoid multiple notifications.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method, and program product to determine when an individual has been exposed to promotional material such that future material similar to that which the individual was exposed to should either be repeated to reinforce the exposure or muted to avoid spamming the individual.

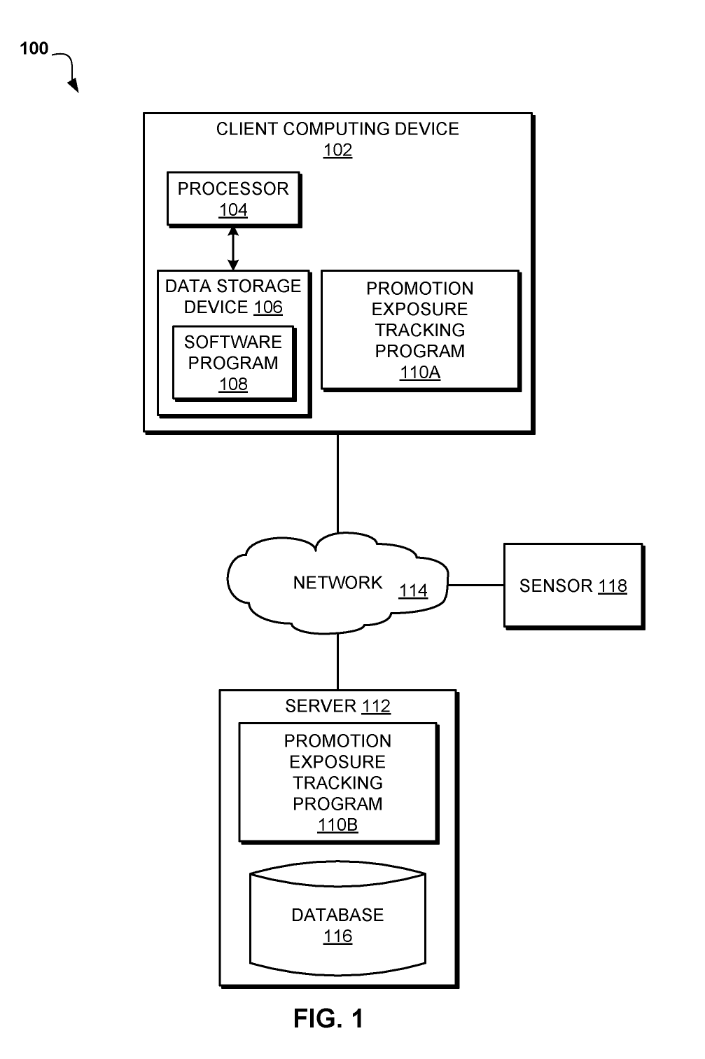

Referring to FIG. 1, an exemplary networked computer environment 100 is depicted, according to at least one embodiment. The networked computer environment 100 may include client computing device 102, a server 112, and a sensor 118 interconnected via a communication network 114. According to at least one implementation, the networked computer environment 100 may include a plurality of client computing devices 102 and servers 112, of which only one of each is shown for illustrative brevity.

The communication network 114 may include various types of communication networks, such as a wide area network (WAN), local area network (LAN), a telecommunication network, a wireless network, a public switched network and/or a satellite network. The communication network 114 may include connections, such as wire, wireless communication links, or fiber optic cables. It may be appreciated that FIG. 1 provides only an illustration of one implementation and does not imply any limitations with regard to the environments in which different embodiments may be implemented. Many modifications to the depicted environments may be made based on design and implementation requirements.

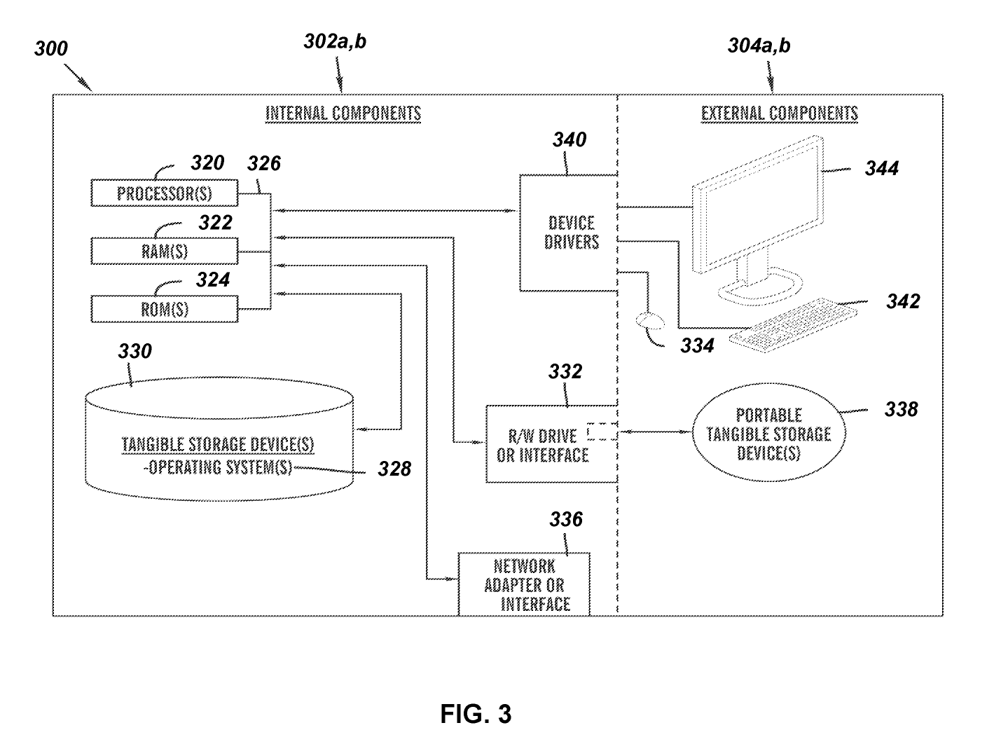

Client computing device 102 may include a processor 104 and a data storage device 106 that is enabled to host and run a software program 108 and a promotion exposure tracking program 110A and communicate with the server 112 via the communication network 114, in accordance with one embodiment of the invention. Client computing device 102 may be, for example, a mobile device, a telephone, a personal digital assistant, a netbook, a laptop computer, a tablet computer, a desktop computer, or any type of computing device capable of running a program and accessing a network. As will be discussed with reference to FIG. 3, the client computing device 102 may include internal components 302a and external components 304a, respectively.

The server computer 112 may be a laptop computer, netbook computer, personal computer (PC), a desktop computer, or any programmable electronic device or any network of programmable electronic devices capable of hosting and running a promotion exposure tracking program 110B and a database 116 and communicating with the client computing device 102 via the communication network 114, in accordance with embodiments of the invention. As will be discussed with reference to FIG. 3, the server computer 112 may include internal components 302b and external components 304b, respectively. The server 112 may also operate in a cloud computing service model, such as Software as a Service (SaaS), Platform as a Service (PaaS), or Infrastructure as a Service (IaaS). The server 112 may also be located in a cloud computing deployment model, such as a private cloud, community cloud, public cloud, or hybrid cloud.

According to the present embodiment, the sensor 118 may be a device capable of capturing audio data and transferring the captured audio data to the client computing device 102 and the server 112 via the network 114. Additionally, the sensor 118 may be directly connected to or internally installed within a user device, such as the client computer device 102. In at least one embodiment, the sensor 118 may also be capable of capturing image data, such as pictures and video, to be used in identifying individuals depicted in the image data using known image recognition techniques.

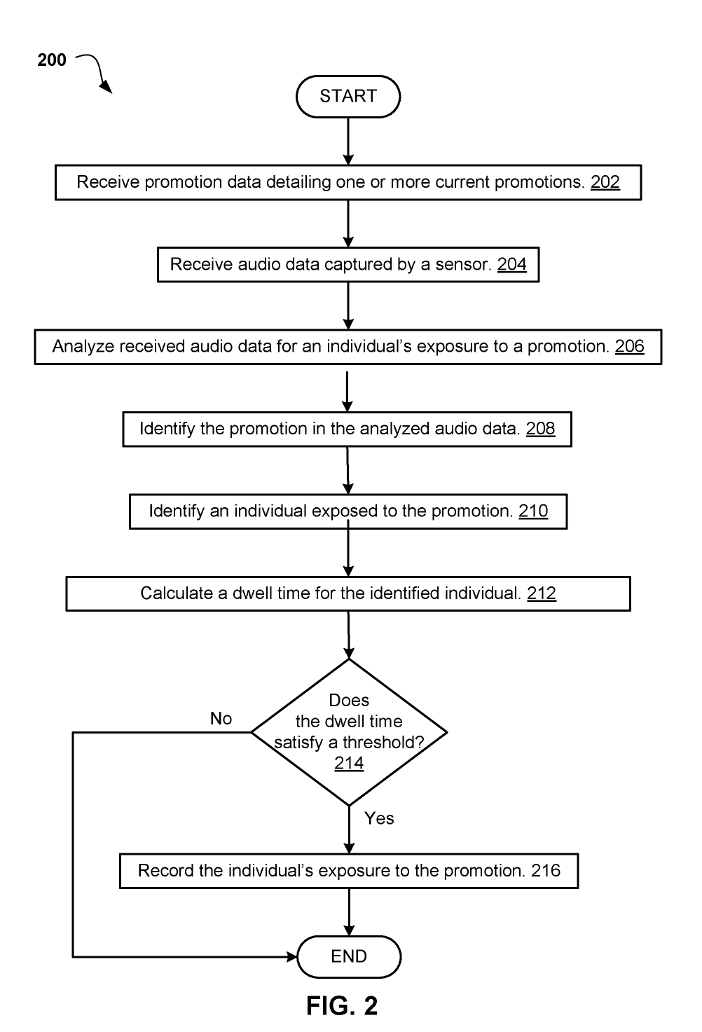

According to the present embodiment, the promotion exposure tracking program 110A, 110B may be a program capable of analyzing audio data captured by the sensor 118 to determine when an individual has been exposed to a promotion. Once the promotion exposure tracking program 110A, 110B determines an individual has been exposed to a promotion, the promotion exposure tracking program 110A, 110B may generate a promotion exposure report that may be stored in a data repository, such as database 116 or transmitted to a user device, such as client computing device 102, for display to a user. Furthermore, the promotion exposure tracking program 110A, 110B may be capable of identifying the individual to which the promotion was exposed using either the captured audio data and/or image data. The promotion exposure tracking method is explained in further detail below with respect to FIG. 2.

Referring now to FIG. 2, an operational flowchart illustrating a promotion exposure tracking process 200 is depicted according to at least one embodiment. At 202, the promotion exposure tracking program 110A, 110B receives promotion data detailing one or more current promotions. Before analyzing whether an individual has been exposed to a promotion, the promotion exposure tracking program 110A, 110B may receive information for all promotions available in a specific location. For example, if the promotion exposure tracking program 110A, 110B is implemented in a grocery store, the promotion exposure tracking program 110A, 110B may first receive all of the promotions the grocery store is currently offering to customers in order to be able to analyze when a customer has been exposed to a particular promotion.

Then, at 204, the promotion exposure tracking program 110A, 110B receives audio data captured by the sensor 118. The sensor 118 may capture the audio data using either an internal or externally-attached microphone. For example, the audio data may be captured from a recording device worn by a grocery store employee. In at least one embodiment, the captured audio data may be paired with image data, such as a video or pictures. For example, the audio data may be received by the promotion exposure tracking program 110A, 110B with security camera footage depicting the environment surrounding the location where the audio data was captured.

Next, at 206, the promotion exposure tracking program 110A, 110B analyzes the received audio data for an individual's exposure to a promotion. The promotion exposure tracking program 110A, 110B may use known active voice recognition technology to analyze the recorded audio data for keywords related to a promotion. For example, if the audio data was captured inside a consumer electronics store, the promotion exposure tracking program 110A, 110B may analyze the audio data for keywords, such as “televisions”, “10% off”, and “on sale”.

Then, at 208, the promotion exposure tracking program 110A, 110B identifies the promotion. Once the promotion exposure tracking program 110A, 110B detects keywords related to a promotion, the promotion exposure tracking program 110A, 110B may identify the promotion to which the individual was exposed. For example, if the promotion exposure tracking program 110A, 110B detects the keywords “televisions”, “10% off”, and “on sale”, the promotion exposure tracking program 110A, 110B may analyze the received promotional data to determine the individual was exposed to a promotion relating to the sale of televisions for 10% off the manufacturer's suggested retail price. In at least one embodiment, the promotion exposure tracking program 110A, 110B may analyze received image data to determine the promotion to which the individual was exposed. For example, the image data may depict the customer viewing a display with a sign stating “10% off 40″ LCD televisions”. The promotion exposure tracking program 110A, 110B may utilize known image recognition technology to capture the displayed text and search the received promotion data for the promotion to which the individual was exposed. In another embodiment, the promotion exposure tracking program 110A, 110B may utilize a combination of the received audio data and the received image data to identify the promotion.

Next, at 210, the promotion exposure tracking program 110A, 110B identifies an individual exposed to the promotion. Once the promotion exposure tracking program 110A, 110B identifies the promotion to which the individual was exposed, the promotion exposure tracking program 110A, 110B may analyze the audio data using known voice recognition techniques to identify the individual. For example, when a customer is approached by a sales representative and informed about a current promotion at the store, audio data may be captured of the conversation between the sales representative and the customer. The promotion exposure tracking program 110A, 110B may analyze the vocal pattern of the customer to determine the customer's identity. To provide an identification of the individual, the promotion exposure tracking program 110A, 110B may search a data repository, such as database 116, for vocal pattern data in order to compare the individual's recorded vocal pattern with known individual vocal patterns. In at least one embodiment, the promotion exposure tracking program 110A, 110B may utilize image data, such as pictures or videos, to identify the individual. For example, the promotion exposure tracking program 110A, 110B may receive security camera footage or body camera footage of the previously described exchange between the sales representative and customer. Using known image recognition techniques, the promotion exposure tracking program 110A, 110B may search a data repository of known customer images to identify the customer conversing with the sales representative through facial pattern analysis. In at least one other embodiment, the promotion exposure tracking program 110A, 110B may identify all individuals within a user preconfigured radius of the promotion exposure. For example, if the preconfigured radius is 10 feet, the promotion exposure tracking program 110A, 110B may analyze all image data and audio data available to identify all individuals within the preconfigured radius.

Then, at 212, the promotion exposure tracking program 110A, 110B calculates a dwell time for the identified individual. Once the individual is identified, the promotion exposure tracking program 110A, 110B may determine the dwell time for the individual. The dwell time may relate to the amount of time the individual spent within a preconfigured distance of the promotion. For example, if a video monitor in a grocery store relayed a “Buy One, Get One” promotion and the user was within a preconfigured distance of the monitor for 20 seconds before walking outside of the preconfigured distance, the promotion exposure tracking program 110A, 110B may calculate the dwell time as 20 seconds. When using audio data, the promotion exposure tracking program 110A, 110B may determine an individual's dwell time based on the volume with which the individual's voice is recorded. For example, an individual may be calculated as being at a certain distance based on the presence of the individual's voice in a recording. Similarly, the promotion exposure tracking program 110A, 110B may determine an individual's presence using only audio data based on known triangulation techniques. For example, if multiple recording devices are utilized, the individual's location may be identified based on the recorded voice of the individual being recorded by multiple sensors 118.

In at least one embodiment, the promotion exposure tracking program 110A, 110B may calculate the dwell time using image data alone or in conjunction with audio data. For example, in a brick-and-mortar retail store setting, the promotion exposure tracking program 110A, 110B may determine the individual is within a preconfigured distance from the promotion by analyzing the recorded image data using known distance calculation techniques.

Next, at 214, the promotion exposure tracking program 110A, 110B determines whether the calculated dwell time satisfies a threshold. According to one implementation, the promotion exposure tracking process 200 may continue along the operation flowchart, if the calculated dwell time satisfies a dwell time threshold. The promotion exposure tracking program 110A, 110B may compare the calculated dwell time to a user preconfigured dwell time threshold to determine is the calculated dwell time satisfies the dwell time threshold. In at least one embodiment, satisfying the dwell time threshold may be the calculated dwell time being at or above the dwell time threshold. In at least one other embodiment, satisfying the dwell time threshold may be the calculated dwell time being below the dwell time threshold. If promotion exposure tracking program 110A, 110B determines the calculated dwell time satisfies the dwell time threshold (step 214, “Yes” branch), the promotion exposure tracking process 200 may continue to step 216 to record the individual's exposure to the promotion. If the promotion exposure tracking program 110A, 110B determines the calculated dwell time does not satisfy the dwell time threshold (step 214, “No” branch), the promotion exposure tracking process 200 may terminate.

Then, at 216, the promotion exposure tracking program 110A, 110B records the individual's exposure to the promotion. Once the promotion exposure tracking program 110A, 110B determines the dwell time threshold has been satisfied, the individual's promotion exposure may be recorded by a tracking system or to a data repository, such as database 116. As previously described, satisfying the dwell time threshold may be the calculated dwell time being below the dwell time threshold. Therefore, in at least one embodiment, the promotion exposure tracking program 110A, 110B may record an individual's lack of exposure to the promotion to the data repository. The information recorded in the data repository may be in a format that can be analyzed and manipulated by a user to understand individual exposure to specific promotion thereby allowing appropriate targeting of future promotions to individuals. For example, the recorded information in the data repository may be used to determine if a marketing agency should reinforce a message by sending a reminder to a consumer after the consumer has been exposed to a promotion or by muting future promotional message to the consumer to avoid spamming the consumer.

It may be appreciated that FIG. 2 provides only an illustration of one implementation and does not imply any limitations with regard to how different embodiments may be implemented. Many modifications to the depicted environments may be made based on design and implementation requirements. Although the above described embodiment utilized the field of medicine as an example, any field that could contain cause and effect connections may be used.

FIG. 3 is a block diagram 300 of internal and external components of the client computing device 102 and the server 112 depicted in FIG. 1 in accordance with an embodiment of the present invention. It should be appreciated that FIG. 3 provides only an illustration of one implementation and does not imply any limitations with regard to the environments in which different embodiments may be implemented. Many modifications to the depicted environments may be made based on design and implementation requirements.

The data processing system 302, 304 is representative of any electronic device capable of executing machine-readable program instructions. The data processing system 302, 304 may be representative of a smart phone, a computer system, PDA, or other electronic devices. Examples of computing systems, environments, and/or configurations that may represented by the data processing system 302, 304 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

The client computing device 102 and the server 112 may include respective sets of internal components 302 a,b and external components 304 a,b illustrated in FIG. 3. Each of the sets of internal components 302 include one or more processors 320, one or more computer-readable RAMs 322, and one or more computer-readable ROMs 324 on one or more buses 326, and one or more operating systems 328 and one or more computer-readable tangible storage devices 330. The one or more operating systems 328, the software program 108 and the promotion exposure tracking program 110A in the client computing device 102 and the promotion exposure tracking program 110B in the server 112 are stored on one or more of the respective computer-readable tangible storage devices 330 for execution by one or more of the respective processors 320 via one or more of the respective RAMs 322 (which typically include cache memory). In the embodiment illustrated in FIG. 3, each of the computer-readable tangible storage devices 330 is a magnetic disk storage device of an internal hard drive. Alternatively, each of the computer-readable tangible storage devices 330 is a semiconductor storage device such as ROM 324, EPROM, flash memory or any other computer-readable tangible storage device that can store a computer program and digital information.

Each set of internal components 302 a,b also includes a R/W drive or interface 332 to read from and write to one or more portable computer-readable tangible storage devices 338 such as a CD-ROM, DVD, memory stick, magnetic tape, magnetic disk, optical disk or semiconductor storage device. A software program, such as the promotion exposure tracking program 110A, 110B, can be stored on one or more of the respective portable computer-readable tangible storage devices 338, read via the respective R/W drive or interface 332, and loaded into the respective hard drive 330.

Each set of internal components 302 a,b also includes network adapters or interfaces 336 such as a TCP/IP adapter cards, wireless Wi-Fi interface cards, or 3G or 4G wireless interface cards or other wired or wireless communication links. The software program 108 and the promotion exposure tracking program 110A in the client computing device 102 and the promotion exposure tracking program 110B in the server 112 can be downloaded to the client computing device 102 and the server 112 from an external computer via a network (for example, the Internet, a local area network or other, wide area network) and respective network adapters or interfaces 336. From the network adapters or interfaces 336, the software program 108 and the promotion exposure tracking program 110A in the client computing device 102 and the promotion exposure tracking program 110B in the server 112 are loaded into the respective hard drive 330. The network may comprise copper wires, optical fibers, wireless transmission, routers, firewalls, switches, gateway computers and/or edge servers.

Each of the sets of external components 304 a,b can include a computer display monitor 344, a keyboard 342, and a computer mouse 334. External components 304 a,b can also include touch screens, virtual keyboards, touch pads, pointing devices, and other human interface devices. Each of the sets of internal components 302 a,b also includes device drivers 340 to interface to computer display monitor 344, keyboard 342, and computer mouse 334. The device drivers 340, R/W drive or interface 332, and network adapter or interface 336 comprise hardware and software (stored in storage device 330 and/or ROM 324).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

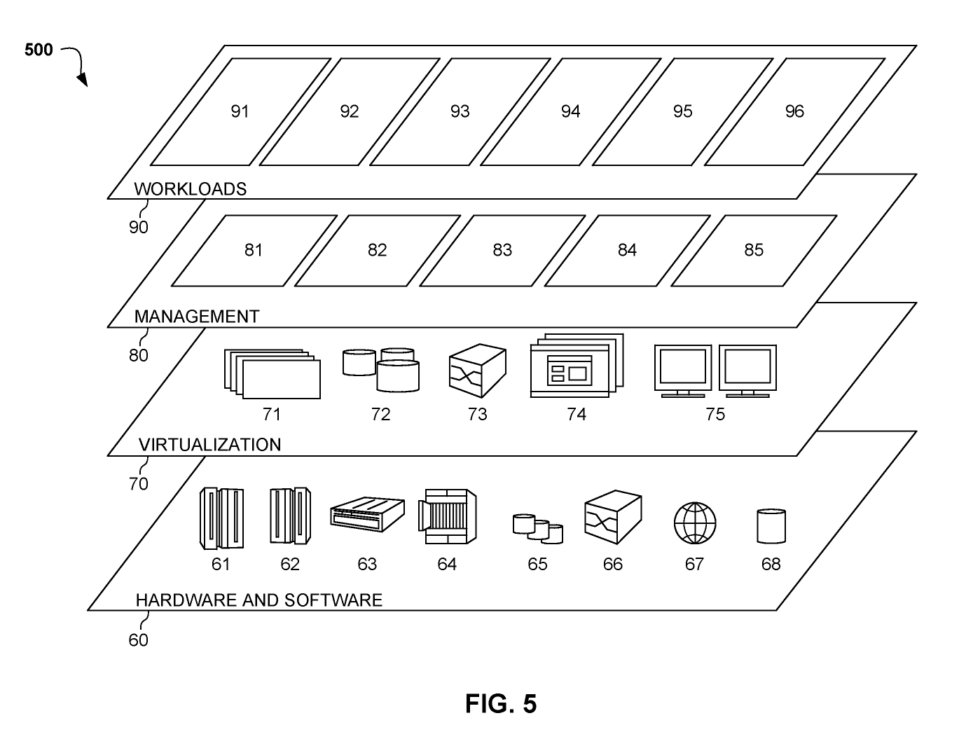

Referring now to FIG. 5, illustrative cloud computing environment 50 is depicted. As shown, cloud computing environment 50 comprises one or more cloud computing nodes 100 with which local computing devices used by cloud consumers, such as, for example, personal digital assistant (PDA) or cellular telephone 54A, desktop computer 54B, laptop computer 54C, and/or automobile computer system 54N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 100 and cloud computing environment 50 can communicate with any type of computerized device over any type of network and/or network addressable connection (e.g., using a web browser).

Referring now to FIG. 6, a set of functional abstraction layers 600 provided by cloud computing environment 50 is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and promotion exposure tracking 96. Promotion exposure tracking 96 may relate to analyzing audio data to determine when an individual has been exposed to a promotion for a sufficient amount of time to understand and consider the promotion, identifying the individual to which the promotion was exposed, and recording the individual's exposure to the promotion for use in advertising campaigns.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method for detecting a promotion exposure, the method comprising:
receiving, by a processor, a plurality of promotional data detailing one or more current promotions;
receiving a plurality of audio data captured by a sensor;
determining an exposure of an individual to a promotion within the one or more current promotions based on the received plurality of audio data and the received plurality of promotional data;
identifying the individual exposed to the promotion using the received plurality of audio data;
calculating a dwell time for the identified individual;
determining the calculated dwell time satisfies a dwell time threshold; and
recording the exposure to a data repository.

2. The method of claim 1, further comprising:
receiving a plurality of image data captured by the sensor, wherein the plurality of image data is selected from a group consisting of a plurality of pictures and a plurality of videos.

3. The method of claim 2, wherein identifying the individual is further based on using the received plurality of image data and a plurality of image recognition technology.

4. The method of claim 1, wherein the calculated dwell time satisfying the dwell time threshold is selected from a group consisting of the calculated dwell time being at or above the dwell time threshold and the calculated dwell time being below the dwell time threshold.

5. The method of claim 2, wherein calculating the dwell time for the identified individual is based on the plurality of received audio data and the plurality of received image data.

6. The method of claim 1, further comprising:
identifying the promotion two which the individual is exposed based on the plurality of received audio data and a plurality of active voice recognition technology.

7. The method of claim 1, wherein the dwell time is a user preconfigured period of time in which the identified individual is within a user preconfigured radial distance from the exposure of the promotion.

8. A computer system for detecting a promotion exposure, the computer system comprising:
one or more processors, one or more computer-readable memories, one or more computer-readable tangible storage media, and program instructions stored on at least one of the one or more tangible storage media for execution by at least one of the one or more processors via at least one of the one or more memories, wherein the computer system is capable of performing a method comprising:
receiving a plurality of promotional data detailing one or more current promotions;
receiving a plurality of audio data captured by a sensor;
determining an exposure of an individual to a promotion within the one or more current promotions based on the received plurality of audio data and the received plurality of promotional data;
identifying the individual exposed to the promotion using the received plurality of audio data;
calculating a dwell time for the identified individual;
determining the calculated dwell time satisfies a dwell time threshold; and
recording the exposure to a data repository.

9. The computer system of claim 8, further comprising:
receiving a plurality of image data captured by the sensor, wherein the plurality of image data is selected from a group consisting of a plurality of pictures and a plurality of videos.

10. The computer system of claim 9, wherein identifying the individual is further based on using the received plurality of image data and a plurality of image recognition technology.

11. The computer system of claim 8, wherein the calculated dwell time satisfying the dwell time threshold is selected from a group consisting of the calculated dwell time being at or above the dwell time threshold and the calculated dwell time being below the dwell time threshold.

12. The computer system of claim 9, wherein calculating the dwell time for the identified individual is based on the plurality of received audio data and the plurality of received image data.

13. The computer system of claim 8, further comprising:
identifying the promotion two which the individual is exposed based on the plurality of received audio data and a plurality of active voice recognition technology.

14. The computer system of claim 8, wherein the dwell time is a user preconfigured period of time in which the identified individual is within a user preconfigured radial distance from the exposure of the promotion.

15. A computer program product for detecting a promotion exposure, the computer program product comprising:
one or more computer-readable tangible storage media and program instructions stored on at least one of the one or more tangible storage media, the program instructions executable by a processor to perform a method, the method comprising:
receiving a plurality of promotional data detailing one or more current promotions;
receiving a plurality of audio data captured by a sensor;
determining an exposure of an individual to a promotion within the one or more current promotions based on the received plurality of audio data and the received plurality of promotional data;
identifying the individual exposed to the promotion using the received plurality of audio data;
calculating a dwell time for the identified individual;
determining the calculated dwell time satisfies a dwell time threshold; and
recording the exposure to a data repository.

16. The computer program product of claim 15, further comprising:
receiving a plurality of image data captured by the sensor, wherein the plurality of image data is selected from a group consisting of a plurality of pictures and a plurality of videos.

17. The computer program product of claim 16, wherein identifying the individual is further based on using the received plurality of image data and a plurality of image recognition technology.

18. The computer program product of claim 15, wherein the calculated dwell time satisfying the dwell time threshold is selected from a group consisting of the calculated dwell time being at or above the dwell time threshold and the calculated dwell time being below the dwell time threshold.

19. The computer program product of claim 16, wherein calculating the dwell time for the identified individual is based on the plurality of received audio data and the plurality of received image data.

20. The computer program product of claim 15, further comprising:
identifying the promotion two which the individual is exposed based on the plurality of received audio data and a plurality of active voice recognition technology.
